(19) United States
(12) Patent Application Publication
(10) Pub. No.: US 2014/0147785 A1
(43) Pub. Date: May 29, 2014

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJI XEROX CO., LTD., TOKYO (JP)

(72) Inventors: Emi MATSUSHITA, Kanagawa (JP); Junichi TOMONAGA, Kanagawa (JP); Yasuo KADOKURA, Kanagawa (JP); Shunsuke NOZAKI, Kanagawa (JP)

(73) Assignee: FUJI XEROX CO., LTD., TOKYO (JP)

(21) Appl. No.: 13/901,051

(22) Filed: May 23, 2013

(30) Foreign Application Priority Data
Nov. 27, 2012 (JP) 2012-259076

(51) Int. Cl. G03G 9/093; G03G 15/08

(52) U.S. Cl. CPC G03G 9/09342; G03G 15/0865
USPC 430/124.1; 430/108.7; 399/262; 399/119; 399/111

(57) ABSTRACT

An electrostatic charge image developing toner includes toner particles containing a binder resin, and first silica particles attached to surfaces of the toner particles, in which the first silica particles are treated with a hydrophobizing agent in supercritical carbon dioxide.

### CROSS-REFERENCE TO RELATED APPLICATIONS

This application is based on and claims priority under 35 USC 119 from Japanese Patent Application No. 2012-259076 filed Nov. 27, 2012.

### BACKGROUND

1. Technical Field

The present invention relates to an electrostatic charge image developing toner, an electrostatic charge image developer, a toner cartridge, a process cartridge, an image forming apparatus, and an image forming method.

2. Related Art

A method for visualizing image information through an electrostatic latent image such as electrophotography has been currently used in various fields. In the electrophotography, an electrostatic latent image which is formed on a photoreceptor by a charging process and an exposure process is developed using a developer containing a toner, and visualized through a transferring process and a fixing process.

As the toner, a toner containing silica particles as an external additive has been known.

### SUMMARY

According to an aspect of the invention, there is provided an electrostatic charge image developing toner including toner particles containing a binder resin, and first silica particles attached to surfaces of the toner particles, in which the first silica particles are treated with a hydrophobizing agent in supercritical carbon dioxide.

### BRIEF DESCRIPTION OF THE DRAWINGS

Exemplary embodiments of the present invention will be described in detail based on the following figures, wherein:

FIG. 1 is a configuration diagram schematically illustrating an example of an image forming apparatus according to an exemplary embodiment; and

FIG. 2 is a configuration diagram schematically illustrating an example of a process cartridge according to an exemplary embodiment.

### DETAILED DESCRIPTION

Exemplary embodiments of the invention will be described below in detail.

Electrostatic Charge Image Developing Toner

An electrostatic charge image developing toner (hereinafter, simply referred to as “toner” in some cases) according to the exemplary embodiment includes toner particles containing a binder resin, and silica particles attached to surfaces of the toner particles. That is, the silica particles are externally added to the toner particles as an external additive.

Then, the silica particles are treated with a hydrophobizing agent in supercritical carbon dioxide.

Here, it is known that the silica particles of which the surfaces are treated with a hydrophobizing agent are used as an external additive.

However, even when the surfaces of the silica particles are treated with a hydrophobizing agent, the silica particles are embedded in the toner particles in some cases in a high temperature and high humidity environment.

The silica particles which are treated with a hydrophobizing agent in the supercritical carbon dioxide are applied to the toner according to the exemplary embodiment, and hence, the silica particles are suppressed from being embedded in the toner particles in a high temperature and high humidity environment.

The reason for this is not clear but is considered to be as follows.

In a high temperature and high humidity environment, an affinity between silanol residues on the surfaces of the silica particles and the binder resin of the toner particles may be considered as a factor by which the silica particles are embedded in the toner particles. This is because the silica particles having a large number of silanol residues and a low hydrophobicity tend to be easily embedded in the toner particles.

On the other hand, when the surfaces of the hydrophilic silica particles are treated with the hydrophobizing agent using a hydrophobizing agent in the supercritical carbon dioxide, a state in which the hydrophobizing agent is dissolved in the supercritical carbon dioxide is made, and the supercritical carbon dioxide has properties of low interfacial tension. Therefore, the hydrophobizing agent in a state of being dissolved in the supercritical carbon dioxide is diffused to and easily reaches deep into holes in the surfaces of the hydrophilic silica particles, together with the supercritical carbon dioxide. Accordingly, it is considered that the hydrophobization treatment is performed to not only the surfaces of the hydrophilic silica particles, but also the depth of the holes.

For this reason, even when the silica particles which are treated with the hydrophobizing agent in the supercritical carbon dioxide have a large number of silanol residues as hydrophilic sol-gel silica particles, the silanol residues in the holes react with the hydrophobizing agent and the silica particles are considered to be silica particles having a small number of silanol residues and a high hydrophobicity.

As a result, the silica particles having a small number of silanol residues and a high hydrophobicity are considered to have low affinity with the binder resin of the toner particles.

From the above, in the toner according to the exemplary embodiment, the silica particles are suppressed from being embedded in the toner particles in a high temperature and high humidity environment, and hence, in the toner according to the exemplary embodiment, it is considered that aggregation (blocking) between the toner particles is suppressed and fluidity of the toner is maintained.

Particularly, when a polyester resin (particularly, crystalline polyester resin) is contained as the binder resin of the toner particles, due to the above reason, the silica particles are easily embedded in the toner particles in a high temperature and high humidity environment. However, the toner according to the exemplary embodiment has an effect that the silica particles are suppressed from being embedded.

In addition, when sol-gel silica particles (silica particles obtained by a sol-gel method) are used as the silica particles, due to the fact that the sol-gel silica particles have more silanol residues on the surfaces and in the holes thereof in comparison with fumed silica particles obtained by a gas phase method and fused silica particles, the silica particles are easily embedded in the toner particles in a high temperature and high humidity environment. However, even when the sol-gel silica particles are used as the silica particles, the toner according to the exemplary embodiment has the effect that the silica particles are suppressed from being embedded.

In addition, this invention may be specified by change of surface area of the toner as follows.

An electrostatic charge image developing toner includes toner particles containing a binder resin; and first silica particles attached to surfaces of the toner particles, wherein the toner satisfies a following formula:

X1≧65%

wherein the X1 is represented by B/A×100 when the surface area of the electrostatic charge image developing toner is A, and the surface area of the electrostatic charge image developing toner obtained after the electrostatic charge image developing toner is allowed to stand for 24 hours in an environment of a temperature of 50° C. and a humidity of 50%, is B. The value of the X1 is preferably equal to or more than 70%.

In addition, it is preferable to satisfy the following condition.

The electrostatic charge image developing toner satisfies a following formula:

X2≧60%

wherein the X2 is represented by C/A×100 when the surface area of the electrostatic charge image developing toner is A, and the surface area of the electrostatic charge image developing toner obtained after the electrostatic charge image developing toner is allowed to stand for 24 hours in an environment of a temperature of 53° C. and a humidity of 50%, is C. The value of the X2 is preferably equal to or more than 65%.

Furthermore, it is considered that in an image forming apparatus using the toner according to the exemplary embodiment, and the like, image defects (for example, uneven image density and color spots) caused by the embed of the silica particles in the toner particles are suppressed.

Hereinafter, each component of the toner according to the exemplary embodiment will be described in detail.

Toner Particles

The toner particles contain, for example, a binder resin, and as necessary, other additives such as a colorant, and a release agent.

Binder Resin

Examples of the binder resin to be used include homopolymers or copolymers synthesized from styrenes (for example, styrene, and chlorostyrene), monoolefins (for example, ethylene, propylene, butylene, and isoprene), vinyl esters (for example, vinyl acetate, vinyl propionate, vinyl benzoate, and vinyl butyrate), α-methylene aliphatic monocarboxylic acid esters (for example, methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate), vinyl ethers (for example, vinyl methyl ether, vinyl ethyl ether, and vinyl butyl ether), and vinyl ketones (for example, vinyl methyl ketone, vinyl hexyl ketone, and vinyl isopropenyl ketone), and polyester resin obtained by copolymerization of dicarboxylic acids and diols.

Among these, as the binder resin, the polyester resin may be preferably used in terms of the above reason. There is no particular limitation to the polyester resin, and examples of the polyester resin include known amorphous polyester resins. As the polyester resin, crystalline polyester resin may be used with the amorphous polyester resin.

Here, the term “crystalline” of the crystalline polyester resin means a resin showing not a stepwise endothermic change but having a clear endothermic peak in differential scanning calorimetry (DSC). Specifically, when the temperature is increased at 10 (° C./min), the temperature of the half value width of the endothermic peak is within 10 (° C.). On the other hand, a resin having a temperature of the half value width of more than 10° C., a resin showing a stepwise endothermic change or a resin having no recognized clear endothermic peak mean that the resin is the amorphous polyester resin (amorphous polymer).

Amorphous Polyester Resin

An example of the amorphous polyester resin includes a condensation polymer of a polyvalent carboxylic acid and a polyol. In addition, as the amorphous polyester resin, commercially available products may be used, or synthetic resins may be used.

Examples of the polyvalent carboxylic acid include aromatic carboxylic acids such as terephthalic acid, isophthalic acid, phthalic anhydride, trimellitic anhydride, pyromellitic acid, and naphthalenedicarboxylic acid; aliphatic carboxylic acids such as maleic anhydride, fumaric acid, succinic acid, alkyenyl succinic anhydride and adipic acid; alicyclic carboxylic acids such as cyclohexane dicarboxylic acid; and anhydrides and lower alkyl esters (a carbon number of from 1 to 5) thereof. Among these polyvalent carboxylic acids, aromatic carboxylic acids are preferably used.

In addition, for the purpose of obtaining excellent fixability, a trivalent or higher-valent carboxylic acid (trimellitic acid and acid anhydride thereof) having a cross-linked structure or a branched structure may also be used with a dicarboxylic acid.

These polyvalent carboxylic acids may be used singly or in combination of two or more kinds.

Examples of the polyol include aliphatic diols such as ethylene glycol, diethylene glycol, triethylene glycol, propylene glycol, butanediol, hexanediol, neopentyl glycol and glycerin; alicyclic diols such as cyclohexanediol, cyclohexanedimethanol and hydrogen-added bisphenol A; and aromatic diols such as ethylene oxide adducts of bisphenol A and propylene oxide adducts of bisphenol A.

Among these polyols, aromatic diols and alicyclic diols are preferably used, and aromatic diols are more preferably used.

In addition, for the purpose of obtaining excellent fixability, a trivalent or higher-valent polyol (glycerin, trimethylolpropane, and pentaerythritol) having a cross-linked structure or a branched structure may also be used with diols.

These polyols may be used singly or in combination of two or more kinds.

The glass transition temperature (Tg) of the amorphous polyester resin is preferably from 50° C. to 80° C. When Tg is lower than 50° C., a problem arises in some cases from the viewpoints of toner storability and fixed image storability. When Tg is higher than 80° C., fixation at a low temperature is difficult in some cases in comparison with the case in the related art.

Tg of the amorphous polyester resin is more preferably from 50° C. to 65° C.

In addition, the glass transition temperature of the amorphous polyester resin is calculated from a DSC curve obtained by differential scanning calorimetry (DSC) and more specifically, the glass transition temperature of the amorphous polyester resin is calculated according to “extrapolated glass transition starting temperature” described in a method for calculating glass transition temperature in “Testing methods for transition temperatures of plastics” of JIS K-1987.

The molecular weight of the amorphous polyester resin is measured by gel permeation chromatography (GPC) of tetrahydrofuran (THF) soluble portion and the weight average molecular weight (Mw) of the amorphous polyester resin is preferably from 5,000 to 1,000,000, and more preferably from 7,000 to 500,000. In addition, the number average molecular weight (Mn) of the amorphous polyester resin is preferably from 2,000 to 100,000. In addition, the molecular weight distribution Mw/Mn is preferably from 1.5 to 100, and more preferably from 2 to 60.

The weight average molecular weight of the amorphous polyester resin may be measured by gel permeation chromatography (GPC). The molecular weight measurement by GPC is performed using GPC HLC-8120 (manufactured by Tosoh Corporation) as a measurement device, and TSKgel Super HM-M (15 cm) (manufactured by Tosoh Corporation) as a column, with a THF solvent. The weight average molecular weight is calculated by using a molecular weight calibration curve that is made by monodisperse polystyrene standard samples prepared from the results of the above measurement. Hereinafter, the same is applied.

The amorphous polyester resin may be prepared using a known preparation method, and for example, there may be a method of preparing a polyester resin at a polymerization temperature in a range from 180° C. to 230° C. by reducing the pressure in the reaction system, as necessary, and reacting raw materials while removing water and alcohol generated during condensation.

In addition, when raw material monomers do not dissolve or compatible with each other at the reaction temperature, a solvent having a high boiling point may be added thereto as a dissolution aid, in order to dissolve the monomers. In this case, the polycondensation reaction is performed while distilling off the dissolution aid. When a monomer having a poor compatibility is present in the copolymerization reaction, the polycondensation reaction may be performed with the main component by previously condensing the monomer having a poor compatibility with the acid or alcohol to be polycondensed with the monomer.

The content of the amorphous polyester resin is preferably in a range of from 40% by weight to 95% by weight, more preferably in a range of from 50% by weight to 90% by weight, and even more preferably in a range of from 60% by weight to 85% by weight.

Crystalline Polyester Resin

The crystalline polyester resin may be preferably used with the amorphous polyester resin from the viewpoint of showing a rapid change in viscosity due to heating and furthermore, from the viewpoint of compatibility of mechanical strength and low temperature fixability.

When the crystalline polyester resin is used with the amorphous polyester resin, compatibility with the crystalline polyester resin is improved. Then, the viscosity of the amorphous polyester resin is reduced according to reduction of viscosity at the melting temperature of the crystalline polyester resin, which is preferable in low temperature fixability since sharp meltability (sharp melting properties) as a toner is easily obtained. In addition, since favorable wettability of the crystalline polyester resin and the amorphous polyester resin are obtained, dispersibility of the crystalline polyester resin in the toner particles is improved, and exposure of the crystalline polyester resin to the surface of the toner is suppressed. Therefore, an adverse influence on charging properties is easily suppressed. Furthermore, due to this reason, the use of the crystalline polyester resin and the amorphous polyester resin is preferable from the viewpoint of improving the toner particle strength and the fixed image strength.

An example of the crystalline polyester resin includes a polycondensation product of a polyvalent carboxylic acid and a polyol. In addition, as the crystalline polyester resin, commercially available products may be used, or synthetic resins may be used.

In order to easily form a crystal structure, a polycondensation product using a polymerizable monomer including linear aliphatic components is more preferable as the crystalline polyester resin, compared to a polymerizable monomer including aromatic components. Furthermore, polymerizable monomer-derived components are preferably equal to or more than 30 mol % respectively, as a single kind in the polymer in order not to deteriorate the crystallinity.

Examples of the polyvalent carboxylic acid include aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid and 1, 18-octadecanedicarboxylic acid; aromatic dicarboxylic acids including diprotic acids such as phthalic acid, isophthalic acid, terephthalic acid, naphthalene-2,6-dicarboxylic acid, malonic acid, and mesaconic acid; and anhydrides or lower alkyl esters (a carbon number of from 1 to 5) thereof.

As the polyvalent carboxylic acid, there may be additionally a trivalent carboxylic acid, and specific examples of the trivalent carboxylic acid include aromatic carboxylic acids such as 1,2,3-benzenetricarboxylic acid, 1,2,4-benzenetricarboxylic acid, and 1,2,4-naphthalenetricarboxylic acid, and the anhydrides or lower alkyl esters (a carbon number of from 1 to 5) thereof.

These polyvalent carboxylic acids may be used singly or in combination of two or more kinds.

These polyvalent carboxylic acids may be used with a dicarboxylic acid having a sulfonic acid group and a dicarboxylic acid having a double bond.

Examples of the polyol include aliphatic diols, and specific examples thereof include a linear aliphatic diol having a main chain carbon number in a range of from 7 to 20. When the aliphatic diol is a branched type, crystallinity of a polyester resin is decreased, and a melting temperature is depressed in some cases. In addition, when the main chain carbon number is less than 7, in the case of polycondensation with aromatic dicarboxylic acid, a melting temperature is increased, and low temperature fixing is difficult in some cases. On the other hand, when the main chain carbon number is more than 20, it is likely to become difficult to obtain a practical material. It is more preferable that a main chain carbon number be equal to or less than 14.

Specific examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosane decanediol. However, there is no limitation thereto. Among these, 1,8-octanediol, 1,9-nonanediol, and 1,10-decanediol are preferable in respect that these are easily obtained.

Examples of the polyol additionally include trivalent or higher-valent alcohols, and specific examples thereof include glycerin, trimethylolethane, trimethylolpropane, and pentaerythritol.

These polyols may be used singly or in combination of two or more kinds.

Here, in the polyol components, the content of the aliphatic diol is preferably equal to or more than 80 mol %, and more preferably equal to or more than 90 mol %. When the content of the aliphatic diol is less than 80 mol %, the crystallinity of the polyester resin is decreased, and the melting temperature is decreased. Therefore, toner blocking resistance, image storability and fixability is difficult to be controlled in some cases.

The melting temperature of the crystalline polyester resin is preferably in a range of from 50° C. to 100° C., more preferably in a range of from 55° C. to 90° C., and even more preferably in a range of from 60° C. to 85° C. from the viewpoints of storability and low temperature fixability. When the melting temperature is less than 50° C., there may be problems in toner storability such as blocking in a stored toner, and fixed image storability after fixation. In addition, when the melting temperature is more than 100° C., sufficient low temperature fixability may not be obtained in some cases.

In addition, the melting temperature of the crystalline polyester resin is calculated from the DSC curve according to a “melting peak temperature” described in a method for calculating melting temperature in “Testing methods for transition temperatures of plastics” of JIS K-1987.

The weight average molecular weight (Mw) of the crystalline polyester resin is preferably from 6,000 to 35,000. When the weight average molecular weight (Mw) is less than 6,000, during fixation, the toner penetrates into a surface of a recording medium such as paper to cause fixing unevenness, or the strength against the crease resistance of the fixed image is decreased in some cases. In addition, when the weight average molecular weight (Mw) is more than 35,000, the temperature for allowing the resin to reach a suitable viscosity for fixing is increased since the viscosity during melting is increased too much, and as a result, the control of low temperature fixability is difficult in some cases.

For example, the crystalline polyester resin may be prepared using a known preparation method as in the amorphous polyester.

The content of the crystalline polyester resin is preferably in a range of from 3% by weight to 40% by weight, more preferably in a range of from 4% by weight to 35% by weight, and even more preferably in a range of from 5% by weight to 30% by weight.

Colorant

There is no particular limitation to the colorant as long as it is a known colorant. Examples thereof include carbon black such as furnace black, channel black, acetylene black and thermal black, inorganic pigments such as colcothar, Prussian blue and titanium oxide, azo pigments such as fast yellow, disazo yellow, pyrazolone red, chelate red, brilliant carmine and para brown, phthalocyanine pigments such as copper phthalocyanine and metal-free phthalocyanine, and condensed polycyclic pigments such as flavanthrone yellow, dibromoanthrone orange, perylene red, quinacridone red and dioxazine violet.

Regarding the colorant, as necessary, a surface-treated colorant may be used and a dispersant may be used in combination. In addition, plural kinds of colorants may be used in combination.

The content of the colorant is preferably in a range of from 1 part by weight to 30 parts by weight with respect to 100 parts by weight of the binder resin.

Release Agent

Examples of the release agent include hydrocarbon wax; natural wax such as carnauba wax, rice wax and candelilla wax; synthetic or mineral and petroleum wax such as montan wax; and ester wax such as fatty acid ester and montanic acid ester. However, there is no limitation thereto.

From the viewpoint of storability, the melting temperature of the release agent is preferably equal to or more than 50° C., and more preferably equal to or more than 60° C. In addition, from the viewpoint of offset resistance, the melting temperature is preferably equal to or less than 110° C., and more preferably equal to or less than 100° C.

The content of the release agent is preferably, for example, in a range of from 2 parts by weight to 30 parts by weight with respect to 100 parts by weight of the binder resin.

Other Additives

Examples of the other additives include a magnetic material, a charge control agent, and an inorganic powder. These additives are contained in the toner particles as an internal additive.

Characteristics of Toner Particles and the Like

The toner particles may be toner particles having a single layer structure, or may be toner particles having a so-called core-shell structure constituted by a core portion (core particle) and a cover layer (shell layer) covering the core portion.

Here, the toner particles having a core-shell structure may be constituted by the core portion containing a binder resin, and, as necessary, other additives such as a colorant and a release agent, and the cover layer containing a binder resin.

For example, the volume average particle size (D50v) of the toner particles is preferably from 2 μm to 10 μm, and more preferably from 4 μm to 8 μm.

As the particle size distribution of the toner particles, a volume average particle size distribution index (GSDv) is preferably from 1.13 to 1.25, and more preferably from 1.15 to 1.19.

When the particle size distribution of the toner particles is in the above range, nonuniformity in the surface area of the toner particles is decreased. As a result, nonuniformity in the attachment state of the silica particles may be suppressed so that variation in charging performance may be suppressed.

Here, the values of the volume average particle size (D50v) and volume average particle size distribution index (GSDv) of the toner particles are measured to be calculated as below.

First, from the particle size ranges (channels) into which the particle size distribution of the toner particles measured using a measuring instrument such as a Coulter counter TA-II (manufactured by Beckman Coulter, Inc.) and a Coulter multisizer II (manufactured by Beckman Coulter, Inc) is divided, the cumulative distribution of the volume and the number of each of the toner particles is determined starting from the small size particles, whereby the particle size reaching cumulative 16% is defined as a volume average particle size D16v, and the particle size reaching cumulative 50% is defined as a volume average particle size D50v. Moreover, the particle size reaching cumulative 84% is defined as a volume average particle size D84v. Then, the volume average particle size distribution index (GSDv) is defined as (D84v/D16v)^{1/2} using D16v and D84v among these particle sizes.

Silica Particles

The first silica particles are silica particles surface-treated in the supercritical carbon dioxide by a hydrophobizing agent (the particle size of the silica particles is not limited; however, for convenience, hereinafter, referred to as “large size silica particles”).

The large size silica particles may be any particle containing silica, that is, SiO₂ as a main component, and may be crystalline or amorphous. In addition, the large size silica particles may be particles prepared using a silicon compound such as liquid glass or an alkoxysilane as a raw material, and may be particles obtained by pulverizing quartz.

Specifically, examples of the large size silica particles include sol-gel silica particles, aqueous colloidal silica particles, alcoholic silica particles, fumed silica particles obtained by a gas phase method, and fused silica particles, and among these, the sol-gel silica particles are preferable.

The volume average particle size of the large size silica particles is preferably equal to or less than 300 nm, more preferably from 60 nm to 300 nm, and even more preferably from 100 nm to 200 nm.

Since the large size silica particles have a large number of pores on the surfaces, and tend to hardly obtain the effect of hydrophobization treatment by the supercritical carbon dioxide in the depth of the particles, the silanol residues easily remain. When the volume average particle size is equal to or less than 300 nm, the residual materials of the silanol residues are decreased and the detachment of the large size silica particles from the surface of the toner particles is easily suppressed. In addition, particularly, when the volume average particle size is set to be equal to or more than 60 nm, the silica particles are suppressed from being embedded in the toner particles, and hydrophobization is more easily controlled so that fluidity reduction is easily suppressed.

The volume average particle size of the large size silica particles means a 50% diameter (D50v) in a cumulative frequency of circle-corresponding diameters obtained by observing 100 primary particles of sol-gel silica particles after externally adding sol-gel silica into the toner particles by a scanning electron microscope (SEM) apparatus and then performing an image analysis of the primary particles, and is measured using this method.

The average circularity of the large size silica particles is preferably, for example, equal to or more than 0.5, more preferably from 0.5 to 0.85, and even more preferably from 0.7 to 0.8.

When the average circularity of the large size silica particles is equal to or more than 0.5, the breakage of the silica particles due to external stress is easily suppressed, and fluidity is easily controlled.

Particularly, the large size silica particles may have a spherical shape or an irregular shape. However, since the silica particles are made to have an irregular shape with the average circularity from 0.5 to 0.85, the silica particles are easily suppressed from being embedded in the toner particles. In addition, the large size silica particles do not easily roll on the surfaces of the toner particles so that migration to the concave portion of the toner particles is easily suppressed. As a result, fluidity is easily controlled.

The circularity of the large size silica particles is obtained as “100/SF2” which is calculated according to the following equation by observing primary particles of sol-gel silica particles after externally adding sol-gel silica into the toner particles by a scanning electron microscope (SEM) apparatus and then performing an image analysis of the obtained primary particles.

circularity(100/SF2)=4π×(A/I²) Equation:

(In the equation, I represents a circumferential length of the primary particles of the large size silica particles on the image, A represents a projected area of the primary particles of the large size silica particles, and SF2 represents a shape factor.)

Then, the average circularity of the large size silica particles is obtained as a 50% circularity in a cumulative frequency of circle-corresponding diameters of 100 primary particles obtained by the above image analysis.

The hydrophobicity of the large size silica particles is preferably, for example, equal to or more than 60%, and more preferably equal to or more than 65%.

When the hydrophobicity of the large size silica particles is equal to or more than 60%, the silica particles are easily prevented from being embedded in the toner particles in a high temperature and high humidity environment.

For the hydrophobicity of the large size silica particles, 50 ml of ion-exchanged water, and 0.2 part of the large size silica particles which is a sample are put in a beaker, and methanol is added dropwise to the mixture from a burette while the mixture is stirred using a magnetic stirrer so that a weight fraction of methanol is obtained as the hydrophobicity in a methanol/water mixed solution at an endpoint at which the whole sample settles.

The external addition amount (addition amount) of the large size silica particles is preferably, for example, from 0.3% by weight to 15% by weight, and more preferably from 0.5% by weight to 10% by weight with respect to a total weight amount of the toner particles.

Method for Preparing Large size Silica Particles

The large size silica particles may be obtained through a treatment with the hydrophobizing agent in the supercritical carbon dioxide after the preparation of the silica particles.

Here, in the method for preparing the large size silica particles, supercritical carbon dioxide is used in a hydrophobization treatment process of the silica particles using a hydrophobizing agent. However, supercritical carbon dioxide may be used in other preparation processes (for example, a solvent removing process) of the large size silica particles.

As the method for preparing large size silica particles using supercritical carbon dioxide in other preparation processes, for example, there may be a method for preparing the large size silica particles having a process of preparing a large size silica particle dispersion containing large size silica particles and a solvent including an alcohol and water (hereinafter, referred to as “dispersion preparing process”), a process of removing the solvent from the large size silica particle dispersion by circulating supercritical carbon dioxide (hereinafter, referred to as “solvent removing process”), and a process of performing a hydrophobization treatment on the surfaces of the large size silica particles after removing the solvent using a hydrophobizing agent in the supercritical carbon dioxide (hereinafter, referred to as “hydrophobization treatment process”).

In the method for preparing large size silica particles using supercritical carbon dioxide in other preparation processes, the silica particles are easily prevented from being embedded in the toner particles in a high temperature and high humidity environment.

In addition, in the method for preparing large size silica particles using supercritical carbon dioxide in other preparation processes, generation of coarse powder is suppressed.

The reason for this is not clear, but is considered to be as follows: 1) when the solvent of the large size silica particle dispersion is removed, it is considered that due to the properties that supercritical carbon dioxide has “no interfacial tension”, the solvent may be removed without causing aggregation among the particles by a liquid cross-linking force during the removal of the solvent, and 2) it is considered that due to the properties that supercritical carbon dioxide “is carbon dioxide in the state under the temperature and pressure of equal to or more than a critical point and has both diffusivity of gas and solubility of liquid”, the contact with supercritical carbon dioxide is performed with high efficiency at a relatively low temperature (for example, equal to or less than 250° C.), so as to dissolve the solvent. Accordingly, by removing the supercritical carbon dioxide having the solvent dissolved therein, the solvent in the large size silica particle dispersion may be removed without causing generation of coarse powder such as secondary aggregates and the like by condensation of silanol groups.

Here, the solvent removing process and the hydrophobization treatment process may be performed separately. However, it is preferable that the solvent removing process and the hydrophobization treatment process be consecutively performed (that is, each process is performed in a sealed state under atmospheric pressure). Each of the processes is consecutively performed, and the large size silica particles lose a chance to adsorb moisture after the solvent removing process, and in a state in which an excessive amount of moisture is suppressed from being adsorbed onto the large size silica particles, the hydrophobization treatment process is performed. Due to this, there is no need that a large amount of the hydrophobizing agent be used or reaction be promoted at a high temperature by excessively heating to perform a surface treatment process and a hydrophobization treatment process. Therefore, more effectively, generation of coarse powder is suppressed.

Hereinafter, each process in the method for preparing large size silica particles using supercritical carbon dioxide in other preparation processes will be described in detail.

The method for preparing the large size silica particles according to the exemplary embodiment is not limited thereto and for example, there may be 1) a method of using supercritical carbon dioxide only in a hydrophobization treatment process, 2) a method of preparing dry large size silica particles in advance and performing a hydrophobization treatment process thereon, and 3) a method of separately performing each process.

Hereinafter, each process will be described in detail.

Dispersion Preparing Process

In the dispersion preparing process, for example, a large size silica particle dispersion containing large size silica particles and a solvent including an alcohol and water is prepared.

Specifically, for example, in the dispersion preparing process, the large size silica particle dispersion is produced by a wet-type method (for example, a sol-gel method) and prepared. Particularly, the large silica dispersion is prepared by the sol-gel method as a wet-type method, and specifically, it is preferable that a tetraalkoxysilane be subjected to a reaction (hydrolysis reaction and condensation reaction) in the presence of an alkaline catalyst in a solvent of an alcohol and water, thereby producing large size silica particles, and producing a large size silica particle dispersion therefrom.

In the dispersion preparing process, for example, when the large size silica particles are obtained by a wet-type method, a dispersion in which the large size silica particles are dispersed in the solvent (large size silica particle dispersion) is obtained.

Here, during the transition to the solvent removing process, the large size silica particle dispersion to be prepared preferably has a weight ratio of water to the alcohol, of for example, from 0.1 to 1.0, more preferably from 0.15 to 0.5, and even more preferably from 0.2 to 0.3.

In the large size silica particle dispersion, when the weight ratio of water to the alcohol is in the above range, generation of coarse powder of large size silica particles is reduced after the hydrophobization treatment, and large size silica particles having favorable electrical resistance with a high hydrophobicity are obtained easily.

When the weight ratio of water to the alcohol is less than 0.1, condensation of the silanol groups on the large size silica particle surfaces in the solvent removing process is reduced during the removal of the solvent, the amount of moisture to be adsorbed onto the large size silica particle surfaces after the removal of the solvent is increased, and accordingly, the electrical resistance of the large size silica particles after the hydrophobization treatment is lowered too far in some cases. Furthermore, when the weight ratio of water to the alcohol is more than 1.0, a large amount of water remains at around the end point of the removal of the solvent in the large size silica particle dispersion in the solvent removing process, aggregation among the large size silica particles by a liquid cross-linking force easily occurs and is present as coarse powder after the hydrophobization treatment in some cases.

During the transition to the solvent removing process, the large size silica particle dispersion to be prepared preferably has a weight ratio of water to the large size silica particles, of for example, from 0.02 to 3, more preferably from 0.05 to 1, and even more preferably from 0.1 to 0.5.

In the large size silica particle dispersion, when the weight ratio of water to the large size silica particles is in the above range, generation of coarse powder of large size silica particles is reduced, and large size silica particles having a high hydrophobicity are obtained easily.

When the weight ratio of water to the large size silica particles is less than 0.02, in the solvent removing process, condensation of the silanol groups on the large size silica particle surfaces is extremely reduced during the removal of the solvent, the amount of moisture to be adsorbed onto the large size silica particle surfaces after the removal of the solvent is increased, and accordingly, the hydrophobicity of the large size silica particles is lowered too far in some cases.

Further, when the weight ratio of water is more than 3, a large amount of water remains at around the endpoint of the removal of the solvent in the large size silica particle dispersion in the solvent removing process, and aggregation among the large size silica particles by a liquid cross-linking force easily occurs in some cases.

In addition, during the transition to the solvent removing process, the large size silica particle dispersion to be prepared preferably has a weight ratio of the large size silica particles to the large size silica particle dispersion, of for example, from 0.05 to 0.7, more preferably from 0.2 to 0.65, and even more preferably from 0.3 to 0.6.

When the weight ratio of the large size silica particles to the large size silica particle dispersion is less than 0.05, in the solvent removing process, the amount of supercritical carbon dioxide to be used is increased, and the productivity is lowered in some cases.

Furthermore, when the weight ratio of the large size silica particles to the large size silica particle dispersion is more than 0.7, the distance between the large size silica particles in the large size silica particles dispersion is decreased, and accordingly, aggregation of the large size silica particles or generation of coarse powder by gelation easily occurs in some cases.

Solvent Removing Process

The solvent removing process is, for example, a process of circulating supercritical carbon dioxide to remove the solvent in the large size silica particle dispersion.

That is, the solvent removing process is a process in which the supercritical carbon dioxide is brought into contact with the large size silica particle dispersion by circulating the supercritical carbon dioxide to remove the solvent.

In the solvent removing process, specifically, for example, the large size silica particle dispersion is put into a sealed reaction vessel. Thereafter, liquefied carbon dioxide is added into the sealed reaction vessel, and heated, and the pressure of the inside of the reaction vessel is elevated by a high-pressure pump to bring the carbon dioxide into a supercritical state. Further, supercritical carbon dioxide is introduced into and discharged from the sealed reaction vessel at the same time, and circulated into the sealed reaction vessel, that is, into the large size silica particle dispersion.

By this, while dissolving and entraining a solvent (an alcohol and water), the supercritical carbon dioxide is discharged to the outside of the large size silica particle dispersion (the outside of the sealed reaction vessel) to remove the solvent.

Herein, the supercritical carbon dioxide refers to carbon dioxide which is in the state under the temperature and pressure, each of which is equal to or higher than a critical point, and has both diffusivity of gas and solubility of liquid.

The temperature condition for the removal of the solvent, that is, the temperature of the supercritical carbon dioxide is preferably, for example, from 31° C. to 350° C., more preferably from 60° C. to 300° C., and even more preferably from 80° C. to 250° C.

When the temperature is lower than the above range, it is difficult for the solvent to be dissolved in supercritical carbon dioxide, and thus, it is difficult to remove the solvent in some cases. Further, it is considered that coarse powder is easily generated by a liquid cross-linking force of the solvent or supercritical carbon dioxide in some cases. On the other hand, when the temperature is higher than the above range, it is considered that coarse powder such as secondary aggregates is easily generated by condensation of the silanol groups on the large size silica particle surfaces in some cases.

The pressure condition for the removal of the solvent, that is, the pressure of the supercritical carbon dioxide is preferably, for example, from 7.38 MPa to 40 MPa, more preferably from 10 MPa to 35 MPa, and even more preferably from 15 MPa to 25 MPa.

When the pressure is less than the above range, the solvent tends to hardly dissolve in the supercritical carbon dioxide, whereas when the pressure is higher than the above range, the equipment tends to be expensive.

Furthermore, the amount of introduction or discharge of supercritical carbon dioxide into the sealed reaction vessel is preferably, for example, from 15.4 L/min/m³ to 1540 L/min/m³, and more preferably from 77 L/min/m³ to 770 L/min/m³.

When the amount of introduction or discharge is less than 15.4 L/min/m³, it takes time for removal of the solvent, and thus, the productivity tends to be decreased.

On the other hand, when the amount of introduction or discharge is more than 1540 L/min/m³, supercritical carbon dioxide is subject to a short pass, thus, the contact time with the large size silica particle dispersion becomes shorter, and thus, there is a tendency that the solvent may not be removed efficiently.

Hydrophobization Treatment Process

The hydrophobization treatment process is a process of performing a hydrophobization treatment on the surfaces of large size silica particles using a hydrophobizing agent in supercritical carbon dioxide following the solvent removing process.

That is, in the hydrophobization treatment process, for example, before the transition from the solvent removing process, the surfaces of the large size silica particles are treated with a hydrophobizing agent in supercritical carbon dioxide in a sealed state.

Specifically, in the hydrophobization treatment process, for example, after stop of the introduction and discharge of the supercritical carbon dioxide into and from the sealed reaction vessel in the solvent removing process, the temperature and pressure of the inside of the sealed reaction vessel are adjusted, and in a state in which the supercritical carbon dioxide is present, a hydrophobizing agent is added into the sealed reaction vessel at a constant ratio with respect to the large size silica particles. Then, in a state of maintaining this state, that is, a hydrophobizing agent being subjected to a reaction in supercritical carbon dioxide, a hydrophobization treatment on the large size silica particles is performed. After the end of the reaction, the inside of the sealed reaction vessel is reduced in pressure and cooled.

In addition, in the solvent removing process, when a hydrophobizing agent is added before removing water and the alcohol, the hydrolysis reaction and condensation reaction of the hydrophobizing agent do not appropriately occur, and aggregated particles are generated or the hydrophobizing agent is easily detached and aggregated in some cases.

Here, in the hydrophobization treatment process, the hydrophobization treatment may be performed in the supercritical carbon dioxide (that is, under the supercritical carbon dioxide atmosphere), while the supercritical carbon dioxide is circulated (that is, the introduction or discharge of the supercritical carbon dioxide into or from the sealed reaction vessel), the hydrophobization treatment may be performed, or the hydrophobization treatment may be performed while the supercritical carbon dioxide is not circulated.

In the hydrophobization treatment process, the amount of the large size silica particles with respect to the volume of the reaction vessel (that is, a feed amount) is preferably, for example, from 30 g/L to 600 g/L, more preferably from 50 g/L to 500 g/L, and even more preferably from 80 g/L to 400 g/L.

When the amount is less than the above range, the concentration of the hydrophobizing agent with respect to supercritical carbon dioxide is lowered to reduce a contact probability with the silica surface and a hydrophobization reaction proceeds with difficulty in some cases. On the other hand, when the amount is more than the above range, the concentration of the hydrophobizing agent with respect to supercritical carbon dioxide is increased and the hydrophobizing agent is not completely dissolved in the supercritical carbon dioxide to cause a poor dispersion so that coarse aggregates are easily generated.

The density of the supercritical carbon dioxide is preferably, for example, from 0.10 g/ml to 0.80 g/ml, more preferably from 0.10 g/ml to 0.60 g/ml, and even more preferably from 0.2 g/ml to 0.50 g/ml.

When the density is less than the above range, the solubility of the hydrophobizing agent with respect to the supercritical carbon dioxide is lowered and aggregates tend to be easily generated. On the other hand, when the density is more than the above range, diffusivity to fine pores of the silica is lowered and hence, the hydrophobization treatment is insufficiently performed in some cases. Particularly, the sol-gel silica particles containing a large number of silanol groups may be preferably treated with a hydrophobizing agent in the above density range.

The density of the supercritical carbon dioxide is adjusted by temperature, pressure and the like.

Examples of the hydrophobizing agent include known silicon compounds containing an alkyl group (for example, a methyl group, an ethyl group, a propyl group, and a butyl group). Specific examples thereof include silazane compounds (for example, hexamethyldisilazane, and tetramethyldisilazane); and silane compounds (for example, methyltrimethoxysilane, dimethyldimethoxysilane, trimethylchlorosilane, and trimethylmethoxysilane). The hydrophobizing agent may be used singly or in combination of plural kinds thereof.

Among these hydrophobizing agents, silicon compounds each containing a trimethyl group, such as trimethylmethoxysilane, and hexamethyldisilazane, are suitable.

There is no particular limitation to the amount of the hydrophobizing agent used. However, in order to obtain the effect of hydrophobization, for example, the amount of the hydrophobizing agent used with respect to the large size silica particles is preferably, for example, from 0.1% by weight to 60% by weight, more preferably 0.5% by weight to 40% by weight, and even more preferably from 1% by weight to 30% by weight.

Here, the temperature condition for the hydrophobization treatment (temperature condition in the reaction), that is, the temperature of the supercritical carbon dioxide is preferably, for example, from 80° C. to 300° C., more preferably from 100° C. to 250° C., and even more preferably from 120° C. to 200° C.

When the temperature is less than the above range, reactivity of the hydrophobizing agent and the large size silica particle surfaces is lowered in some cases. On the other hand, when the temperature is more than the above rage, the condensation reaction of the silanol groups of the large size silica particles is promoted and thus, aggregated particles are generated in some cases. Particularly, the hydrophobization treatment may be preferably performed on the sol-gel silica having a large number of silanol groups in the above temperature range.

On the other hand, the pressure condition for the hydrophobization treatment (pressure condition in the reaction), that is, the pressure of the supercritical carbon dioxide is preferable as long as it is under the condition that satisfies the above density, and for example, preferably from 8 MPa to 30 MPa, more preferably from 10 MPa to 25 MPa, and even more preferably from 15 MPa to 20 MPa.

The large size silica particles may be obtained through each of the above-described processes.

Other Components

In the toner according to the exemplary embodiment, other external additives other than the large size silica particles may be attached onto the toner particles.

Examples of the external additives include inorganic particles such as alumina, titanium oxide, barium titanate, magnesium titanate, calcium titanate, strontium titanate, zinc oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide and silicon nitride. Also, resin particles such as fluorocarbon resins and silicone resins and particles of metal salts of higher fatty acids represented by zinc stearate may be used.

Particularly, in the toner according to the exemplary embodiment, the volume average particle size of the large size silica particles is set from 60 nm to 300 nm, and smaller diameter silica particles (second silica) having a volume average particle size of equal to or less than 40 nm (hereinafter, referred to as “small diameter silica particles”) may be preferably used in combination. That is, the large size silica particles having a volume average particle size of from 60 nm to 300 nm which are treated with the hydrophobizing agent in the supercritical carbon dioxide, and the small diameter silica particles having a volume average particle size of equal to or less than 40 nm (preferably from 5 nm to 40 nm, and more preferably from 5 nm to 30 nm) may be preferably attached onto the surfaces of the toner particles. Due to this, the large size silica particles are easily suppressed from being embedded in the toner particles.

The external addition amount (addition amount) of the small diameter silica particles is preferably, for example, from 0.3% by weight to 3.0% by weight, and more preferably from 0.5% by weight to 2.0% by weight, with respect to the total amount of the toner particles.

The small diameter silica particles may be or may not be treated with the hydrophobizing agent in the supercritical carbon dioxide. In addition, the small diameter silica particles may have either of a spherical shape or an irregular shape and as long as the particles satisfy the above particle size range, any preparation method thereof may be used.

Method for Preparing Toner

Next, the method for preparing the toner according to the exemplary embodiment will be described.

The toner according to the exemplary embodiment may be obtained by after the preparation of the toner particles, externally adding the large size silica particles to the toner particles.

As the method for preparing the toner particles, there are a kneading and pulverization method and a wet granulation method. However, it is preferable to produce the toner particles by a wet granulation method in which the material on the surface becomes more even and hence, there is a small difference between the toner particles with respect to the embed of the large size silica particles and other external additives thereof. Examples of the wet granulation method include known methods such as a suspension polymerization method, a dissolution suspension method, and an emulsion aggregation and coalescence method. As the wet granulation method, an emulsion aggregation and coalescence method by which the shape is further controlled and a difference in shape between the toner particles is small is particularly preferable.

As a method for externally adding the large size silica particles and other external additives to the obtained toner particles, there is a method for achieving mixing by a known mixer, for example, a V-type blender, a Henschel mixer, and a Loedige mixer.

Electrostatic Charge Image Developer

The electrostatic charge image developer according to an exemplary embodiment is a developer including at least the toner according to the exemplary embodiment.

The electrostatic charge image developer according to the exemplary embodiment may be a single-component developer containing only the toner according to the exemplary embodiment, or may be a two-component developer containing a mixture of the toner and a carrier.

There is no particular limitation to the carrier and known carriers can be used. Examples of the carrier include a resin coated carrier, and a magnetic material dispersed carrier.

In the two-component developer, a mixing ratio (weight ratio) of the toner according to the exemplary embodiment and the carrier is preferably in the range of from about 1:100 to about 30:100, and more preferably in the range of from about 3:100 to about 20:100 in terms of a ratio of the toner to the carrier.

Image Forming Apparatus and Image Forming Method

Next, the image forming apparatus and the image forming method according to the exemplary embodiment, each of which uses the toner (electrostatic charge image developer) according to the exemplary embodiment, will be described.

The image forming apparatus according to the exemplary embodiment includes an image holding member; a charging unit that charges the image holding member; a latent image forming unit that forms an electrostatic latent image on the surface of the image holding member; a developing unit that accommodates the electrostatic charge image developer according to the exemplary embodiment, and develops the electrostatic latent image formed on the surface of the image holding member as a toner image using the electrostatic charge image developer; a transfer unit that transfers the toner image onto a recording medium; and a fixing unit that fixes the toner image transferred onto the recording medium.

In the image forming apparatus according to the exemplary embodiment, there is carried out an image forming method according to the exemplary embodiment including a charging process of charging an image holding member; an electrostatic charge image forming process of forming an electrostatic latent image on the surface of the charged image holding member; a developing process of developing the electrostatic latent image formed on the surface of the image holding member with the electrostatic charge image developer according to the exemplary embodiment to form a toner image; a transfer process of transferring the toner image onto a recording medium; and a fixing process of fixing the toner image transferred onto the recording medium.

In the image forming apparatus according to the exemplary embodiment, for example, a portion including the developing unit may have a cartridge structure (process cartridge) which is detachably attached to the image forming apparatus, and as the process cartridge, a process cartridge which accommodates the electrostatic charge image developer according to the exemplary embodiment and is provided with a developing unit that develops an electrostatic charge image formed on the surface of the image holding member with the electrostatic charge image developer as a toner image is suitably used.

Hereinafter, an example of the image forming apparatus according to the exemplary embodiment will be described. However, there is no limitation thereto. In addition, main components shown in the drawing will be described, and the descriptions of the other components will be omitted.

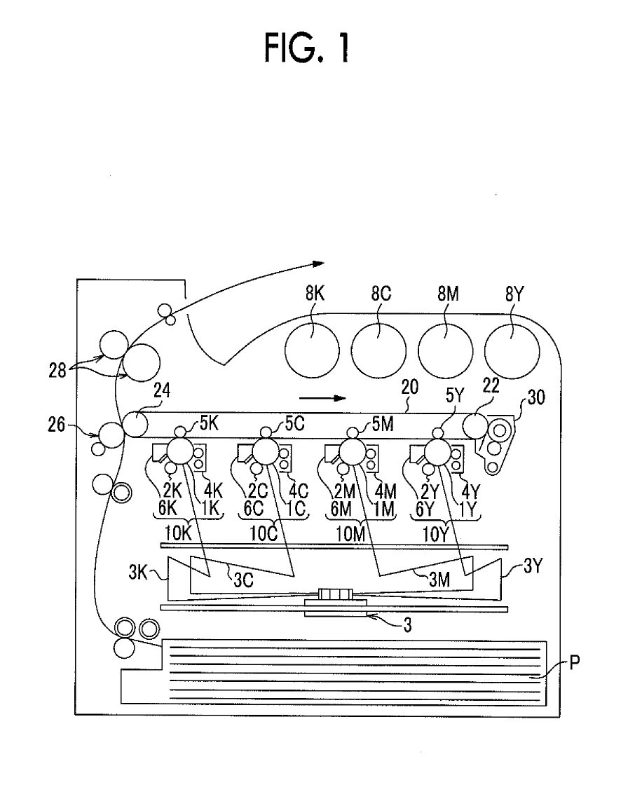

FIG. 1 is a diagram schematically illustrating the configuration of a four-tandem color image forming apparatus. The image forming apparatus shown in FIG. 1 includes first to fourth electrophotographic image forming units (image forming units) 10Y, 10M, 10C, and 10K which output images of the respective colors including yellow (Y), magenta (M), cyan (C), and black (K) on the basis of color-separated image data. These image forming units (hereinafter, also referred to simply as “unit” or “units” in some cases) 10Y, 10M, 10C and 10K are arranged horizontally in a line with predetermined distances therebetween.

Incidentally, each of these units 10Y, 10M, 10C and 10K may be a process cartridge which is detachably attached to the image forming apparatus.

An intermediate transfer belt 20 (an example of an intermediate transfer body) is provided extending above each of the units 10Y, 10M, 10C and 10K in the drawing through each unit. The intermediate transfer belt 20 is provided around a drive roller 22 and a support roller 24 contacting the inner surface of the intermediate transfer belt 20, which are separated from left to right in the drawing. The intermediate transfer belt 20 travels in a direction from the first unit 10Y to the fourth unit 10K. Incidentally, the support roller 24 is biased in a direction of separation from the drive roller 22 by a spring or the like (not shown), such that tension is applied to the intermediate transfer belt 20 which is provided around the support roller 24 and the drive roller 22. Also, on the surface of the image holding member side of the intermediate transfer belt 20, an intermediate transfer body cleaning device 30 is provided opposing to the drive roller 22.

Also, toners in the four colors of yellow, magenta, cyan and black, which are stored in toner cartridges 8Y, 8M, 8C and 8K, respectively, are supplied to developing devices 4Y, 4M, 4C and 4K of the above-described units 10Y, 10M, 10C and 10K, respectively.

Since the first to fourth units 10Y, 10M, 10C, and 10K have the same configuration, the first unit 10Y, which is provided on the upstream side in the travelling direction of the intermediate transfer belt and forms a yellow image, will be described as a representative example. In addition, the same components as those of the first unit 10Y are represented by reference numerals to which the symbols M (magenta), C (cyan), and K (black) are attached instead of the symbol Y (yellow), and the descriptions of the second to fourth units 10M, 10C, and 10K, will be omitted.

The first unit 10Y includes a photoreceptor 1Y (an example of the image holding member). In the surroundings of the photoreceptor 1Y, there are successively disposed a charging device 2Y (for example, charge roller: an example of developing unit) for charging the surface of the photoreceptor 1Y to a predetermined potential; an exposing device 3 (an example of an electrostatic charge image forming unit) for exposing the charged surface with a laser beam 3Y on the basis of a color-separated image signal to form an electrostatic charge image; the developing device 4Y (an example of the developing unit) for supplying a charged toner into the electrostatic charge image to develop the electrostatic charge image; a primary transfer device 5Y (for example, primary transfer roller: primary transfer unit) for transferring the developed toner image onto the intermediate transfer belt 20; and a photoreceptor cleaning device 6Y (an example of cleaning unit) for removing the toner remaining on the surface of the photoreceptor 1Y after the primary transfer.

The primary transfer device 5Y is disposed inside the intermediate transfer belt 20 and provided opposite the photoreceptor 1Y. Furthermore, bias power supplies (not shown), which apply primary transfer biases, are respectively connected to the primary transfer devices 5Y, 5M, 5C and 5K. A controller (not shown) controls the respective bias power supplies to change the transfer biases which are applied to the respective primary transfer devices.

Hereinafter, the operation of forming a yellow image in the first unit 10Y will be described. First, before the operation, the surface of the photoreceptor 1Y is charged to a potential of about −600 V to about −800 V by the charging device 2Y.

The photoreceptor 1Y is formed by laminating a photosensitive layer on a conductive substrate (volume resistivity at 20° C.: 1×10⁻⁶ Ωcm or lower). In general, this photosensitive layer has high resistance (resistance similar to that of general resin), and has a property in which, when irradiated with the laser beam 3Y, the specific resistance of a portion irradiated with the laser beam changes. Therefore, the charged surface of the photoreceptor 1Y is irradiated with the laser beam 3Y through the exposure device 3 in accordance with yellow image data which is output from the controller (not shown). The laser beam 3Y is emitted to the photosensitive layer on the surface of the photoreceptor 1Y. As a result, an electrostatic charge image having a yellow printing pattern is formed on the surface of the photoreceptor 1Y.

The electrostatic charge image is an image which is formed on the surface of the photoreceptor 1Y through charging and a so-called negative latent image which is formed through the following processes: the specific resistance of a portion, which is irradiated with the laser beam 3Y, of the photosensitive layer is reduced and electric charge flows on the surface of the photoreceptor 1Y whereas electric charge remains on a portion which is not irradiated with the laser beam 3Y.

The electrostatic charge image which is formed on the photoreceptor 1Y in this manner is rotated to a predetermined development position along with the travel of the photoreceptor 1Y. At this development position, the electrostatic charge image on the photoreceptor 1Y is visualized (developed) by the developing device 4Y.

The developing device 4Y accommodates, for example, the electrostatic charge image developer according to the exemplary embodiment, which includes at least a yellow toner and a carrier. The yellow toner is subjected to frictional charging upon being stirred within the developing device 4Y, has a charge with the same polarity (negative polarity) as that of a charge charged on the photoreceptor 1Y and is held on a developer roller (developer holding member). When the surface of the photoreceptor 1Y passes through the developing device 4Y, the yellow toner electrostatically attaches to a latent image portion at which the charge is erased from the surface of the photoreceptor 1Y, and the latent image is developed with the yellow toner. The photoreceptor 1Y on which a yellow toner image is formed subsequently travels at a predetermined speed, and the toner image developed on the photoreceptor 1Y is transported to a predetermined primary transfer position.

When the yellow toner image on the photoconductor 1Y is transported to the primary transfer position, a predetermined primary transfer bias is applied to the primary transfer device 5Y, an electrostatic force directed from the photoreceptor 1Y toward the primary transfer device 5Y acts upon the toner image, and the toner image on the photoreceptor 1Y is transferred onto the intermediate transfer belt 20. At this time, the transfer bias to be applied has a (positive) polarity opposite to that of the toner (having a negative polarity). For example, the first unit 10Y is controlled to about +10 μA by the controller (not shown).

Meanwhile, the toner remaining on the photoreceptor 1Y is removed by the cleaning device 6Y and collected.

Also, primary transfer biases to be applied respectively to the primary transfer devices 5M, 5C and 5K of the second unit 10M and the subsequent units are controlled similarly to the primary transfer bias of the first unit.

In this manner, the intermediate transfer belt 20 having a yellow toner image transferred thereonto in the first unit 10Y is sequentially transported through the second to fourth units 10M, 10C and 10K, and toner images of respective colors are superposed and multi-transferred.

The intermediate transfer belt 20 having the four color toner images multi-transferred thereonto through the first to fourth units arrives at a secondary transfer portion which is configured with the intermediate transfer belt 20, the support roller 24 contacting the inner surface of the intermediate transfer belt and a secondary transfer device 26 (for example, secondary transfer roller: secondary transfer unit) disposed on the side of the image holding surface of the intermediate transfer belt 20.

Meanwhile, a recording paper P (an example of a recording medium) is supplied at a predetermined timing through a supply mechanism to a gap at which the secondary transfer device 26 and the intermediate transfer belt 20 are brought into press contact with each other, and a secondary transfer bias is applied to the support roller 24. At this time, the transfer bias to be applied has the same (negative) polarity as that of the toner (also having a negative polarity), and an electrostatic force directed from the intermediate transfer belt 20 toward the recording paper P acts upon the toner image, whereby the toner image on the intermediate transfer belt 20 is transferred onto the recording paper P. Incidentally, on this occasion, the secondary transfer bias is determined depending upon a resistance detected by a resistance detecting unit (not shown) for detecting a resistance of the secondary transfer portion, and the voltage is controlled.

The primary transfer device, the intermediate transfer belt and the secondary transfer device each correspond to an example of the transfer unit.

Thereafter, the recording paper P is sent to a press part (nip part) of a pair of fixing rollers in a fixing device 28 (an example of the fixing unit), and the toner image is heated, whereby the toner image having colors superposed thereon is melted and fixed onto the recording paper P.

Examples of the recording medium onto which the toner image is transferred include plain papers and OHP sheets used for copiers, printers and the like of an electrophotographic system.

The recording paper P having fixed color image is transported to an ejection portion, whereby a series of the color image formation operations ends.

Incidentally, the above-exemplified image forming apparatus has such a configuration in which a toner image is transferred onto the recording paper P via the intermediate transfer belt 20. However, there is no limitation to the configuration, and the embodiment may also have a structure in which a toner image is transferred directly from the photoreceptor to the recording paper.

Process Cartridge and Toner Cartridge

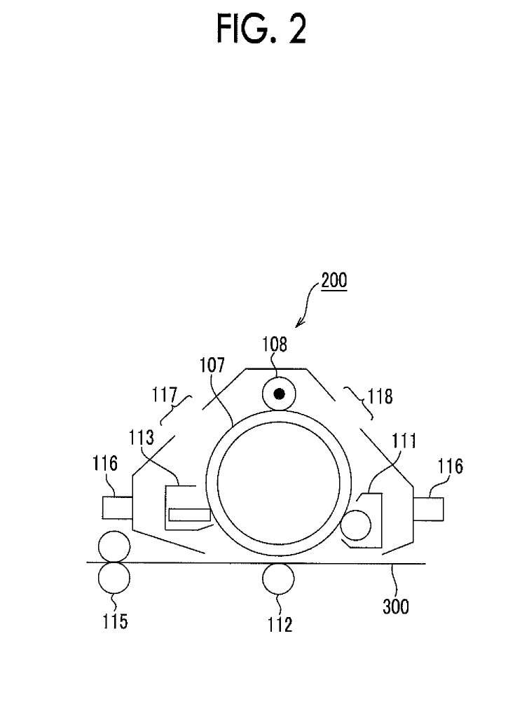

FIG. 2 is a diagrammatic configuration view showing a suitable example of a process cartridge for storing the electrostatic charge image developer according to the exemplary embodiment. A process cartridge 200 includes, integrally, a charging device 108, a developing device 111, a photoreceptor cleaning device 113, an opening portion 118 for exposure and an opening portion 117 for erasing exposure, together with a photoreceptor 107, all of which are combined using a mounting rail 116. Incidentally, in FIG. 2, a reference numeral 300 refers to recording paper (recording medium).

Then, this process cartridge 200 is detachably attached to an image forming apparatus constituted of a transfer device 112, a fixing device 115 and other constituent portions (not shown).

The process cartridge 200 shown in FIG. 2 is provided with the charging device 108, the developing device 111, the cleaning device 113, the opening portion 118 for exposure and the opening portion 117 for erasing exposure; however, these devices may be selectively combined.

It is sufficient that the process cartridge according to the exemplary embodiment be provided with a developing unit (developing device 111 in FIG. 2), and the process cartridge is preferably provided with at least one member selected from the group consisting of the photoreceptor 107, the charging device 108, the cleaning device 113, the opening portion 118 for exposure and the opening portion 117 for erasing exposure.

Next, the toner cartridge according to the exemplary embodiment is described. The toner cartridge according to the exemplary embodiment is a toner cartridge which is mounted detachably against the image forming apparatus and accommodates at least a toner according to the exemplary embodiment therein to be supplied to the developing unit provided in the image forming apparatus, and the toner is the electrostatic charge image developing toner according to the exemplary embodiment already mentioned. It is sufficient that toner cartridge according to the exemplary embodiment accommodates at least a toner, and according to the configuration of the image forming apparatus, for example, the cartridge may accommodate a developer.

Accordingly, the electrostatic image developing toner according to the exemplary embodiment is easily supplied to the image forming apparatus having a configuration in which the toner cartridge is detachably attached using a toner cartridge accommodating the electrostatic image developing toner according to the exemplary embodiment therein.

The image forming apparatus shown in FIG. 1 is an image forming apparatus having a configuration in which the toner cartridges 8Y, 8M, 8C and 8K are detachably attached, and the developing devices 4Y, 4M, 4C, and 4K are connected to toner cartridges corresponding to the respective developing devices (colors) via a toner supply tube (not shown). Also, in the case where the toner stored in the toner cartridge runs low, the toner cartridge is exchanged.

### EXAMPLES

The exemplary embodiments are more specifically described below with reference to the following Examples and Comparative Examples, but it should be construed that the exemplary embodiments are not limited to these Examples. Incidentally, in the following description, all “parts” are “parts by weight”, respectively unless otherwise indicated.

Production of Large Size Silica Particles

Production of Large Size Silica Particles (S1)

Preparation of Large Size Silica Particle Dispersion (S1)

In a glass reaction vessel provided with a stirrer, a dropping nozzle and a thermometer, 300 parts of methanol and 52 parts of 10% ammonia water are added and mixed, an alkali catalyst solution thereby being obtained.

This alkali catalyst solution is adjusted to 30° C., and then while the alkali catalyst solution is stirred, the dropwise addition of 440 parts of tetramethoxysilane and the dropwise addition of 290 parts of 3.8% ammonia water are simultaneously performed in 60 minutes to obtain an irregular shaped hydrophilic large size silica particle dispersion (solid content of 9.5% by weight) having a volume average particle size (referred to as D50v) of 120 nm and an average circularity of 0.82.

The supply amount of the tetraalkoxysilane is 0.0053 mol/(mol·min) with respect to the number of moles of alcohol in the alkali catalyst solution. The amount of NH₃ per mole of the total amount of supply of the tetraalkoxysilane supplied in one minute is 0.27 mole.

Then, the obtained large size silica particle dispersion is concentrated to a solid content of 40% by weight using a rotary filter R-fine (manufactured by KOTOBUKI KOGYO CO., LTD.). The concentrated product is denoted as a large size silica particle dispersion (S1).

Hydrophobization Treatment of Large Size Silica Particles

As shown below, together with a solvent removing process of the large size silica particle dispersion (S1), the large size silica particles are treated with a hydrophobizing agent using a hydrophobizing agent. In the hydrophobization treatment, a device provided with a carbon dioxide cylinder, a carbon dioxide pump, an entrainer pump, an autoclave with a stirrer (capacitance: 500 ml), and a pressure valve is used.

First, 300 parts of the large size silica particle dispersion (S1) is put in the autoclave with a stirrer (capacitance: 500 ml) and the stirrer is rotated at 100 rpm. Then, the autoclave is filled with liquid carbon dioxide. The temperature in the autoclave is increased to 150° C. by a heater, and then a pressure is applied to 15 MPa by the carbon dioxide pump for a supercritical state. While the pressure in the autoclave is maintained at 15 MPa by the pressure valve, supercritical carbon dioxide is circulated by the carbon dioxide pump to remove methanol and water from the large size silica particle dispersion (S1).

Next, at the time point when the circulation amount of the circulated supercritical carbon dioxide (integrated amount: measured as a circulation amount of carbon dioxide in a standard state) is 100 parts, the circulation of the supercritical carbon dioxide is stopped.

Thereafter, while the temperature is maintained at 150° C. by a heater, and the pressure is maintained at 15 MPa by a carbon dioxide pump, in a state in which the supercritical carbon dioxide in the autoclave is maintained, hexamethyldisilazane (HMDS) is added into the autoclave by the entrainer pump as a hydrophobizing agent, stirred, and maintained for 30 minutes. Then, the stirring is stopped, the pressure valve is opened, and the pressure in the autoclave is opened to atmospheric pressure to cool the mixture to room temperature (25° C.)

In this manner, the solvent removing process and the hydrophobization treatment using a hydrophobizing agent are sequentially performed to obtain large size silica particles (S1).

The hydrophobicity of the obtained large size silica particles (S1) is 67.

Production of Large Size Silica Particles (S2) to (S9), Large Size Silica Particles (CS1) and (CS2), and Small Size Silica Particles (S20)

Large size silica particles (S2) to (S9), large size silica particles (CS1) and (CS2), and small size silica particles (S20) are produced in the same manner as in the preparation of the large size silica particle dispersion (S1), except that the alkali catalyst solution (methanol amount and 10% ammonia water amount), particle generation conditions

(total dropwise addition amount of tetramethoxysilane (referred to as TMOS) and 3.8% ammonia water in the alkali catalyst solution and dropwise addition time), and hydrophobization treatment conditions (atmosphere and treatment time) used in the preparation of the large size silica particle dispersion (S1) are changed as shown in Table 1.

Synthesis of Amorphous Polyester Resin

Synthesis of Amorphous Polyester Resin 1
Bisphenol A ethylene oxide 2.2-mol adduct: 40 parts by mole
Bisphenol A propylene oxide 2.2-mol adduct: 60 parts by mole
Terephthalic acid: 47 parts by mole
Fumaric acid: 40 parts by mole
Dodecenyl succinic anhydride: 15 parts by mole
Trimellitic anhydride: 3 parts by mole

The above-described monomer components exclusive of fumaric acid and trimellitic anhydride, and tin dioctanoate in an amount of 0.25 part with respect to the 100 parts of a total sum of the monomer components are put in a reaction vessel provided with a stirrer, a thermometer, a condenser and a nitrogen gas introducing tube. After allowing the mixture to react in a nitrogen gas stream at 235° C. for 6 hours, the temperature is decreased to 200° C., and the above-described fumaric acid and trimellitic anhydride are put in the vessel, followed by allowing the mixture to react for one hour. The temperature is further increased to 220° C. over 4 hours, and the reaction mixture is polymerized under a pressure of 10 kPa until a desired molecular weight is obtained, thereby obtaining a pale yellow transparent amorphous polyester resin 1.

The obtained amorphous polyester resin 1 has a glass transition temperature Tg by DSC of 59° C., a weight average molecular weight Mw by GPC of 25,000, a number average molecular weight Mn of 7,000, a softening temperature by a flow tester of 107° C. and an acid value AV of 13 mgKOH/g.

Preparation of Amorphous Polyester Resin Dispersion

Preparation of Amorphous Polyester Resin Dispersion 1

A mixed solvent of 160 parts of ethyl acetate and 100 parts of isopropyl alcohol are put in a jacketed 3-L reaction vessel provided with a condenser, a thermometer, a water-dropping device and an anchor blade (BJ-30N, manufactured by Tokyo Rikakikai Co., Ltd.) while maintaining the reaction vessel at 40° C. by a water circulating thermostat; 300 parts of the above-described amorphous polyester resin 1 is put in the vessel; and the mixture is dissolved with stirring at 150 rpm using a three-one motor, thereby obtaining an oil phase. To this stirred oil phase, 14 parts of a 10% ammonia aqueous solution is added dropwise for a dropwise addition time of 5 minutes; and after mixing for 10 minutes, 900 parts of ion exchange water is further added dropwise at a rate of 7 parts per minute to cause phase inversion, thereby obtaining an emulsion liquid.

Immediately thereafter, 800 parts of the obtained emulsion liquid and 700 parts of ion exchange water are put in a 2-L eggplant type flask, which is then set in an evaporator (manufactured by Tokyo Rikakikai Co., Ltd.) provided with a vacuum control unit via a trap ball. The eggplant type flask is heated to 60° C. in a hot water bath while rotating and the pressure is reduced to 7 kPa while paying attention such that bumping does not occur, thereby removing the solvent. At a point in time when the amount of solvent collected reaches 1,100 parts, the pressure is returned to atmospheric pressure, and the eggplant type flask is cooled with water to obtain a dispersion. The obtained dispersion is free from a solvent odor. A volume average particle size D50v of the resin particles in this dispersion is 130 nm. Thereafter, ion exchange water is added to adjust a solid content concentration to 20%, and this is denoted as an amorphous polyester resin dispersion 1.

Synthesis of Crystalline Polyester Resin

Synthesis of Crystalline Polyester Resin 1
1,10-Dodecanedioic acid: 50 parts by mole
1,9-Nonanediol: 50 parts by mole

The above-described monomer components are put in a reaction vessel provided with a stirrer, a thermometer, a condenser and a nitrogen gas-introducing tube, and after purging the inside of the reaction vessel with dry nitrogen gas, titanium tetrabutoxide is put in the reaction vessel in an amount of 0.25 part with respect to 100 parts of the above-described monomer components. After allowing the mixture to react with stirring in a nitrogen gas stream at 170° C. for 3 hours, the temperature is further increased to 210° C. over one hour; the pressure inside of the reaction vessel is reduced to 3 kPa; and the reaction is continued with stirring for 13 hours under reduced pressure, thereby obtaining a crystalline polyester resin 1.

The obtained crystalline polyester resin 1 has a melting temperature by DSC of 73.6° C., a weight average molecular weight Mw by GPC of 25,000, a number average molecular weight Mn of 10,500 and an acid value AV of 10.1 mgKOH/g.

Preparation of Crystalline Polyester Resin Dispersion

Preparation of Crystalline Polyester Resin Dispersion 1

300 parts of the above-described crystalline polyester resin, 160 parts of methyl ethyl ketone (solvent) and 100 parts of isopropyl alcohol (solvent) are put in a jacketed 3-L reaction vessel provided with a condenser, a thermometer, a water-dropping device and an anchor blade (BJ-30N, manufactured by Tokyo Rikakikai Co., Ltd.), and the resin is dissolved upon mixing with stirring at 100 rpm while maintaining the mixture at 70° C. by a water circulating thermostat (solution preparing process).

Thereafter, the stirring rotation rate is changed to 150 rpm; the water circulating thermostat is set up at 66° C.; 17 parts of a 10% ammonia water is put into the vessel over 10 minutes; and thereafter, ion exchange water maintained warm at 66° C. is added dropwise in an amount of 900 parts in total at a rate of 7 parts per minute to cause phase inversion, thereby obtaining an emulsion liquid.

Immediately thereafter, 800 parts of the obtained emulsion liquid and 700 parts of ion exchange water are put in a 2-L eggplant type flask, which is then set in an evaporator (manufactured by Tokyo Rikakikai Co., Ltd.) provided with a vacuum control unit via a trap ball. The eggplant type flask is heated to 60° C. in a hot water bath while rotating and the pressure is reduced to 7 kPa while paying attention such that bumping does not occur, thereby removing the solvent. At a point in time when the amount of solvent collected reaches 1,100 parts, the pressure is returned to atmospheric pressure, and the eggplant type flask is cooled with water to obtain a dispersion. The obtained dispersion is free from a solvent odor. A volume average particle size D50v of the resin particles in this dispersion is 130 nm. Thereafter, ion exchange water is added to adjust a solid content concentration to 20%, and this is denoted as a crystalline polyester resin dispersion 1.

Preparation of Colorant Dispersion

Preparation of Black Pigment Dispersion 1
Carbon Black (manufactured by Cabot Corporation, Regal 330): 250 parts
Anionic surfactant (manufactured by Daiichikogyo Seiyaku Co., Ltd, NEOGEN SC): 33 parts (active ingredient content 60%, 8% with respect to the colorant)
Ion exchange water: 750 parts

In a stainless steel vessel having a size such that when the entire amount of the components shown above are put in, the level of the liquid is about one-third of the height of the vessel, 280 parts of ion exchange water and 33 parts of the anionic surfactant are put, and the surfactant is sufficiently dissolved therein. Subsequently, all of the solid solution pigment is put into the vessel, and the mixture is stirred using a stirrer until unwetted pigment is no longer seen, while the mixture is sufficiently defoamed. After defoaming, the rest of the ion exchange water is added, and the resultant is dispersed using a homogenizer (manufactured by IKA GmbH, ULTRA TURRAX T50) at 5000 rpm for 10 minutes, and then the dispersion is defoamed by stirring for one whole day and night using a stirrer. After defoaming, the resultant is dispersed using the homogenizer again at 6000 rpm for 10 minutes, and then the dispersion is defoamed by stirring for one whole day and night using a stirrer. Subsequently, the dispersion is dispersed under a pressure of 240 MPa using a high pressure impact type dispersing machine, ULTIMIZER (manufactured by Sugino Machine, Ltd.; HJP30006). The dispersion is carried out to an extent equivalent to 25 passes in terms of the total feed amount and the processing capability of the device. The dispersion thus obtained is allowed to stand for 72 hours to remove any precipitate, and ion exchange water is added thereto to adjust the solid concentration to 15%. The volume average particle size D50v of the particles in the black pigment dispersion 1 is 135 nm.

Preparation of Release Agent Dispersion

Preparation of Release Agent Dispersion 1
Hydrocarbon wax (manufactured by Nippon Seiro Co., Ltd., trade name: FNP0080, melting temperature: 80° C.): 270 parts
Anionic surfactant (manufactured by Daiichikogyo Seiyaku Co., Ltd, NEOGEN RK, active ingredient content: 60%): 13.5 parts (in terms of active ingredient, 3.0% with respect to the release agent)
Ion exchange water: 21.6 parts

The above components are mixed, and the release agent is dissolved using a pressure discharge homogenizer (manufactured by APV Gaulin, Inc., Gaulin Homogenizer) at an internal liquid temperature of 120° C. Subsequently, the mixture is subjected to a dispersion treatment for 120 minutes at a dispersion pressure of 5 MPa, and for 360 minutes at a dispersion pressure of 40 MPa, and is cooled. Thus, a release agent dispersion 1 is obtained. The volume average particle size D50v of the particles in this release agent dispersion is 225 nm. Subsequently, ion exchange water is added thereto to adjust the solid concentration to 20.0%.

Preparation of Aqueous Solution of Aluminum Sulfate
Aluminum sulfate powder (manufactured by Asada Chemical Industry Co., Ltd.: 17% aluminum sulfate): 35 parts
Ion exchange water: 1,965 parts

The above components are put into a 2-L vessel and are mixed under stirring at 30° C. until precipitates disappear. Thus, an aqueous solution of aluminum sulfate is prepared.

### Example 1

### Preparation of Toner

Amorphous polyester resin dispersion 1: 700 parts
Crystalline polyester resin dispersion 1: 50 parts
Black pigment dispersion 1: 133 parts
Release agent dispersion 1: 100 parts
Ion exchange water: 350 parts
Anionic surfactant (manufactured by Dow Chemical Company, Dowfax 2A1): 2.9 parts

The above components are put into a 3-L reaction vessel provided with a thermometer, a pH meter and a stirrer and 1.0% nitric acid is added thereto at a temperature of 25° C. to adjust the pH to 3.0. Subsequently, while the mixture is dispersed at 5,000 rpm using a homogenizer (manufactured by IKA Japan K.K.; ULTRA TURRAX T50), 130 parts of the prepared aqueous solution of aluminum sulfate is added to the reaction vessel, and the mixture is dispersed for 6 minutes.

Subsequently, the reaction vessel is provided with a stirrer and a mantle heater, and while the rotation rate of the stirrer is adjusted so that the slurry is sufficiently stirred, the temperature is increased at a rate of 0.2° C./min up to a temperature of 40° C., and is increased at a rate of 0.05° C./min over 40° C. The particle size is measured every 10 minutes using a MULTISIZER II (aperture diameter: 50 μm, manufactured by Beckman Coulter, Inc.). When the volume average particle size reaches 5.0 μm, the temperature is maintained, and 50 parts of the amorphous polyester resin dispersion 1 is added thereto over 5 minutes.

The mixture is maintained for 30 minutes, and then the pH is adjusted to 9.0 using a 1% aqueous solution of sodium hydroxide. Subsequently, while the pH is similarly adjusted to 9.0 at every increment of 5° C., the temperature is increased to 90° C. at a rate of temperature increase of 1° C./min, and the mixture is maintained at 98° C. The particle shape and the surface properties are observed using an optical microscope and a scanning electron microscope (FE-SEM), and coalescence of particles is confirmed after 10.0 hours. The reaction vessel is cooled to 30° C. in cooling water over 5 minutes.

The slurry obtained after cooling is passed through a nylon mesh having a mesh size of 15 μm, and coarse powder is removed. The toner slurry that has passed through the mesh is subjected to reduced pressure filtration using an aspirator. The toner left on the filter paper is pulverized by hand as finely as possible, and the pulverized toner is put into ion exchange water in an amount equivalent to 10 times the amount of the toner at a temperature of 30° C. The mixture is mixed under stirring for 30 minutes, and then is subjected again to reduced pressure filtration with an aspirator. The electrical conductivity of the filtrate is measured. This operation is repeated until the electrical conductivity of the filtrate reaches equal to or less than 10 μS/cm, and the toner is washed.

The washed toner is pulverized finely with a wet and dry granulator (COMIL), and then is dried in vacuo in an oven at 35° C. for 36 hours. Thus, toner particles are obtained.

The toner particles thus obtained have a volume average particle size D50v of 6.0 μm, and a shape factor of 0.960 (measured by FPIA-3000; manufactured by Sysmex Corp.). An observation of SEM images of the toner is made, and it is found that the toner particles have smooth surfaces, and defects such as protrusion of the release agent or peeling of the surface layer are not observed.

Production of Toner

2 parts of the large size silica particles (S1) and 1 part of small size silica particles (S2) as external additives are added to 60 parts of the obtained toner particles and the resultant is mixed for 30 seconds at 13,000 rpm using a sample mill. Then, the particles are sieved with a vibration screen having a mesh size of 45 μm, and thus a toner is obtained.

### Examples 2 to 11 and Comparative Examples 1 and 2

Each toner is produced in the same manner as in Example 1 except that the kind of silica particles as an external additive is changed according to Table 2.

However, in Example 10, a commercially available product RY-50 (volume average particle size: 50 nm, manufactured by Nippon Aerosil Co., Ltd.) is added as an external additive instead of the small size silica particles (S20), and a toner is produced.

Evaluation

The toner obtained in each Example is evaluated as below. The results are shown in Table 2.

Embed and Detachment of Large Size Silica Particles

The toner obtained in each Example is stored for one day under 1) the environment of a temperature of 50° C. and a humidity of 50% and 2) the environment of a temperature of 53° C. and a humidity of 50%, and then, the attachment state of the large size silica particles is evaluated as below.

The specific surface area of the toner before and after the storage is measured using a specific surface area measuring device manufactured by Mountech Co., Ltd. (Macsorb HM model-1201). When the specific surface area of the externally added toner is A and the specific surface area of the toner after the storage is B, the suppression state is obtained from the equation of a suppression ratio X=B/A×100 to evaluate the embed and detachment of the large size silica particles.

Evaluation criteria are as follows, and the minimum acceptable level is G3.

G1: Suppression ratio X is from 70% to 100%.

G2: Suppression ratio X is equal to or more than 65% and less than 70%.

G3: Suppression ratio X is equal to or more than 60% and less than 65%.

G4: Suppression ratio X is less than 60%.

Degree of Aggregation (Fluidity) of Toner

The toner obtained in each Example is stored for one day under 1) the environment of a temperature of 50° C. and a humidity of 50% and 2) the environment of a temperature of 53° C. and a humidity of 50%, and then, the degree of aggregation (fluidity) of the toner is evaluated as below.

The measurement is performed by the following method using a powder tester (manufactured by Hosokawa Micron Corporation).

The powder tester is provided with three tiered sieves in which the top sieve has a mesh size of 75 μm, the middle sieve has a mesh size of 45 μm, and the bottom sieve has a mesh size of 22 μm. 2 g of a toner sample is put on the top sieve and the three sieves are vibrated within an amplitude of 1 mm for 30 seconds. The amount of toner remained on each sieve is measured to calculate the degree of aggregation of toner.

Calculation equations are as follows:

(Weight of toner remaining on top sieve)/(Toner sample amount)×100=a; Equation:

(Weight of toner remaining on middle sieve)/(Toner sample amount)×100×0.6=b; Equation:

(Weight of toner remaining on bottom sieve)/(Toner sample amount)×100×0.2=c;and Equation:

Degree of Aggregation=a+b+c. Equation:

The degree of aggregation of toner shown here is a characteristic value showing the fluidity of toner. The lower the value, the higher the fluidity. The higher the value, the higher the degree of aggregation.

Evaluation criteria are as follows, and the minimum acceptable level is C.

A: Degree of aggregation is less than 10%.

B: Degree of aggregation is equal to or more than 10% and less than 20%.

C: Degree of aggregation is equal to or more than 20% and less than 40%.

D: Degree of aggregation is equal to or more than 40%.

TABLE 1

| | | | Particle generation condition | | | | | | | |
|---|---|---|---|---|---|---|---|---|---|---|
| | | | Total drop- | Total drop- | | | | | | |
| | Alkali catalyst solution | | wise addition | wise addition | Dropwise | Hydrophobization | | | | |
| | Methanol | 10% ammonia | amount of | amount of 3.8% | addition | treatment condition | | | | Average |
| | amount | water amount | TMOS | ammonia water | time | | Treatment | Hydro- | D50v | circu- |
| | (parts) | (parts) | (parts) | (parts) | (min) | Atmosphere | time (min) | phobicity | (nm) | larity |
| Large size silica | 300 | 52 | 440 | 290 | 60 | Supercritical | 30 | 67 | 120 | 0.82 |
| particles (S1) | | | | | | carbon dioxide | | | | |
| Large size silica | 300 | 52 | 430 | 290 | 57 | Supercritical | 30 | 60 | 95 | 0.82 |
| particles (S2) | | | | | | carbon dioxide | | | | |
| Large size silica | 300 | 52 | 435 | 290 | 58 | Supercritical | 30 | 63 | 105 | 0.81 |
| particles (S3) | | | | | | carbon dioxide | | | | |
| Large size silica | 300 | 52 | 570 | 290 | 75 | Supercritical | 30 | 70 | 190 | 0.85 |
| particles (S4) | | | | | | carbon dioxide | | | | |
| Large size silica | 300 | 52 | 600 | 290 | 79 | Supercritical | 30 | 73 | 210 | 0.85 |
| particles (S5) | | | | | | carbon dioxide | | | | |
| Large size silica | 300 | 52 | 680 | 290 | 90 | Critical carbon | 30 | 76 | 290 | 0.87 |
| particles (S6) | | | | | | dioxide | | | | |
| Large size silica | 300 | 52 | 710 | 290 | 94 | Critical carbon | 30 | 78 | 310 | 0.89 |
| particles (S7) | | | | | | dioxide | | | | |
| Large size silica | 300 | 52 | 350 | 290 | 46 | Critical carbon | 30 | 60 | 55 | 0.80 |
| particles (S8) | | | | | | dioxide | | | | |
| Large size silica | 300 | 52 | 370 | 290 | 49 | Critical carbon | 30 | 60 | 65 | 0.80 |
| particles (S9) | | | | | | dioxide | | | | |
| Large size silica | 300 | 52 | 440 | 290 | 60 | Air | 240 | 55 | 120 | 0.82 |
| particles (CS1) | | | | | | | | | | |
| Large size silica | 300 | 52 | 440 | 290 | 60 | Air | 240 | 50 | 120 | 0.82 |
| particles (CS2) | | | | | | | | | | |
| Small size silica | 350 | 62 | 300 | 290 | 40 | Supercritical | 30 | 61 | 35 | 0.79 |
| particles (S20) | | | | | | carbon dioxide | | | | |

TABLE 2

| | | Evaluation | | | |
|---|---|---|---|---|---|
| | | Embed and detachment of large size | | Degree of aggregation (Fluidity) | |
| | | silica particles | | of Toner | |
| | | X1: After storage | X2: After storage | After storage in | After storage in |
| | | in environment of | in environment of | environment of | environment of |
| | Silica | temperature of 50° C. | temperature of 53° C. | temperature of 50° C. | temperature of 53° C. |
| | particles No. | and humidity of 50% | and humidity of 50% | and humidity of 50% | and humidity of 50% |
| Example 1 | (S1) + (S20) | G1 | G1 | A | A |
| Example 2 | (S2) + (S20) | G2 | G2 | A | B |
| Example 3 | (S3) + (S20) | G1 | G1 | A | A |
| Example 4 | (S4) + (S20) | G1 | G1 | A | A |
| Example 5 | (S5) + (S20) | G1 | G1 | A | B |
| Example 6 | (S6) + (S20) | G1 | G1 | A | B |
| Example 7 | (S7) + (S20) | G1 | G1 | B | C |
| Example 8 | (S8) + (S20) | G2 | G3 | B | C |
| Example 9 | (S9) + (S20) | G2 | G2 | A | B |
| Example 10 | (S10) + (RY-50) | G1 | G2 | A | B |
| Example 11 | (S1) | G1 | G2 | A | C |
| Comparative | (CS1) | G3 | G4 | C | D |
| Example 1 | | | | | |
| Comparative | (CS2) | G4 | G4 | C | D |
| Example 2 | | | | | |

From the above results, it is found that the evaluations on the embed and detachment of the large size silica particles and the degree of aggregation (fluidity) of toner are favorable in Examples in comparison with Comparative Examples.

In addition, in Examples 1 to 10 in which the small size silica particles are further externally added, it is found that the evaluation on the degree of aggregation (fluidity) of toner is favorable in comparison with Example 11 in which the small size silica particles are not further externally added.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles containing a binder resin; and
first silica particles attached to surfaces of the toner particles,
wherein the first silica particles are treated with a hydrophobizing agent in supercritical carbon dioxide.

2. The electrostatic charge image developing toner according to claim 1,
wherein the binder resin contains a polyester resin.

3. The electrostatic charge image developing toner according to claim 2,
wherein the polyester resin contains a crystalline polyester resin.

4. The electrostatic charge image developing toner according to claim 1,
wherein the toner further comprises second silica particles having a volume average particle size of equal to or less than 40 nm which are attached to the surfaces of the toner particles, and
a volume average particle size of the first silica particles is from 60 nm to 300 nm.

5. The electrostatic charge image developing toner according to claim 4,
wherein the volume average particle size of the second silica particles is equal to or more than 5 nm.

6. The electrostatic charge image developing toner according to claim 1,
wherein a content of the first silica particles is from 0.3% by weight to 15.0% by weight with respect to a total weight of the toner particles.

7. The electrostatic charge image developing toner according to claim 4,
wherein a content of the second silica particles is from 0.3% by weight to 3.0% by weight with respect to a total weight of the toner particles.

8. The electrostatic charge image developing toner according to claim 1,
wherein the volume average particle size of the first silica particles is from 100 nm to 200 nm.

9. The electrostatic charge image developing toner according to claim 1,
wherein a hydrophobicity of the first silica particles is equal to or more than 60%.

10. An electrostatic charge image developer including the electrostatic charge image developing toner according to claim 1.

11. The electrostatic charge image developer according to claim 10,
wherein the electrostatic charge image developing toner further comprises second silica particles having a volume average particle size of equal to or less than 40 nm which are attached to the surfaces of the toner particles, and the volume average particle size of the first silica particles is from 60 nm to 300 nm.

12. A toner cartridge comprising:
a toner accommodating chamber,
wherein the toner accommodating chamber accommodates the electrostatic charge image developing toner according to claim 1.

13. A process cartridge comprising:
an accommodating chamber that accommodates the electrostatic charge image developer according to claim 10; and
a developing unit that develops an electrostatic charge image using the electrostatic charge image developer.

14. An image forming apparatus comprising:
an image holding member;
a charging unit that charges a surface of the image holding member;
a latent image forming unit that forms an electrostatic latent image on the surface of the image holding member;
a developing unit that develops the electrostatic latent image using an electrostatic charge image developer to form a toner image;
a transfer unit that transfers the toner image from the image holding member onto a surface of a recording medium; and
a fixing unit that fixes the toner image which is transferred onto the surface of the recording medium,
wherein the electrostatic charge image developer is the electrostatic charge image developer according to claim 10.

15. A method for forming an image comprising:
charging a surface of an image holding member;
forming an electrostatic latent image on the surface of the image holding member;
developing the electrostatic latent image formed on the surface of the image holding member using an electrostatic charge image developer to form a toner image;
transferring the toner image onto a surface of a recording medium; and
fixing the toner image transferred onto the surface of the recording medium,
wherein the electrostatic charge image developer is the electrostatic charge image developer according to claim 10.

16. An electrostatic charge image developing toner comprising:
toner particles containing a binder resin; and
first silica particles attached to surfaces of the toner particles,
wherein the toner satisfies a following formula:
X1≧65%
wherein the X1 is represented by B/A×100 when the surface area of the electrostatic charge image developing toner is A, and the surface area of the electrostatic charge image developing toner obtained after the electrostatic charge image developing toner is allowed to stand for 24 hours in an environment of a temperature of 50° C. and a humidity of 50%, is B.

17. The electrostatic charge image developing toner according to claim 16,
wherein the toner satisfies a following formula:
X2≧60%
wherein the X2 is represented by C/A×100 when the surface area of the electrostatic charge image developing toner is A, and the surface area of the electrostatic charge image developing toner obtained after the electrostatic charge image developing toner is allowed to stand for 24 hours in an environment of a temperature of 53° C. and a humidity of 50%, is C.

18. The electrostatic charge image developing toner according to claim 16,
wherein the X1 is equal to or more than 70%.

19. The electrostatic charge image developing toner according to claim 17,
wherein the X2 is equal to or more than 65%.
